(19) United States
(12) Patent Application Publication
(10) Pub. No.: US 2016/0092941 A1
(43) Pub. Date: Mar. 31, 2016

(54) METHOD FOR DISPLAYING CLICKABLE ADVERTISEMENT ON WEB BROWSERS

(71) Applicant: Naoya SAKAI, Osaka-fu (JP)

(72) Inventor: Naoya SAKAI, Osaka-fu (JP)

(21) Appl. No.: 14/608,454

(22) Filed: Jan. 29, 2015

(30) Foreign Application Priority Data
Sep. 29, 2014 (JP) 2014-199490

(51) Int. Cl. G06Q 30/02; H04L 29/08

(52) U.S. Cl. CPC G06Q 30/0277; H04L 67/02

(57) ABSTRACT

A method for displaying advertisements on browsers (especially, tab browsers) that are effective and occupies smaller spaces of the screen is disclosed. When a user clicks a link on the screen and a new tab is displayed, the clicked link is replaced with another advertisement link, or another advertisement link is inserted near the clicked link, getting more attention from the user.

### CROSS REFERENCE TO RELATED APPLICATIONS

This U.S. patent application claims priority under 35 U.S.C. §119(e) to Japanese Patent Application No. 2014-199490, filed on Sep. 29, 2014. The disclosure of this prior application is considered part of the disclosure of this application and is hereby incorporated by reference in its entirety.

### TECHNICAL FIELD

The present invention relates to a method for displaying clickable advertisements on web browsers, specifically a method suitable to tab browsers.

### BACKGROUND OF THE INVENTION

Advertisement technologies such as banner ads on web browser pages are now widespread. It is preferable that clickable banner ads and text link ads have high CTR (click through rate), namely a ration of the number of ad clicks to the number of clicks ad displays, and CVR (Conversion rate), namely a ratio of the number of customers' conversion (e.g. becoming a member or buying a product) to the number of clicks.

However, just using larger banners or more banners can have a negative impact to ad efficiency, since it tends to clutter the page layouts and decrease the useful space on the page, which will reduce value of the web pages for the visitor, resulting in fewer ad clicks (or even worse, fewer visitors). It is necessary to keep the space for banner ads minimum, and, at the same time, increase ad effectiveness. Today, there are many advertisement methods to solve this problem.

It is also to be noted that most modern browsers today use tab browser technologies. On tab browsers, a user frequently switches between tabs and deletes unnecessary tabs. Advertisement methods could exploit this behavior, but traditional advertisement methods treated tab browsers as just a combination of traditional single page browsers.

### SUMMARY OF THE INVENTION

One aspect of the disclosed invention is an advertisement display method executed on a web browser, comprising: displaying an object corresponding to the first link in a second screen area in response to a user's click operation on a first link in a first screen area, and replacing the first link in the first screen area with an advertisement link.

Another aspect of the disclosed invention is an advertisement display method executed on a web browser, comprising: displaying information corresponding to the first link in a second screen area in response to a user's click operation on a first link in a first screen area, and inserting an advertisement link near the first link in the first screen area.

Another aspect of the disclosed invention is a non-transitory computer readable medium storing a program causing a computer to execute an advertisement display process executed on a web browser, comprising: displaying an object corresponding to the first link in a second screen area in response to a user's click operation on a first link in a first screen area, and replacing the first link in the first screen area with an advertisement link.

### BRIEF DESCRIPTION OF THE DRAWINGS

FIG. 1 is an overall diagram of an exemplary information system utilizing the present invention.

FIG. 2A, FIG. 2B, and FIG. 2C are exemplary web browser screens utilizing the present invention.

FIG. 3A, FIG. 3B, and FIG. 3C are exemplary web browser screens utilizing the present invention with text link ads.

FIG. 4A, FIG. 4B, and FIG. 4C are other exemplary web browser screens utilizing the present invention with text link ads.

FIG. 5 is an exemplary flow chart to execute a method of the present invention on computers.

### DESCRIPTION OF THE EMBODIMENTS

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

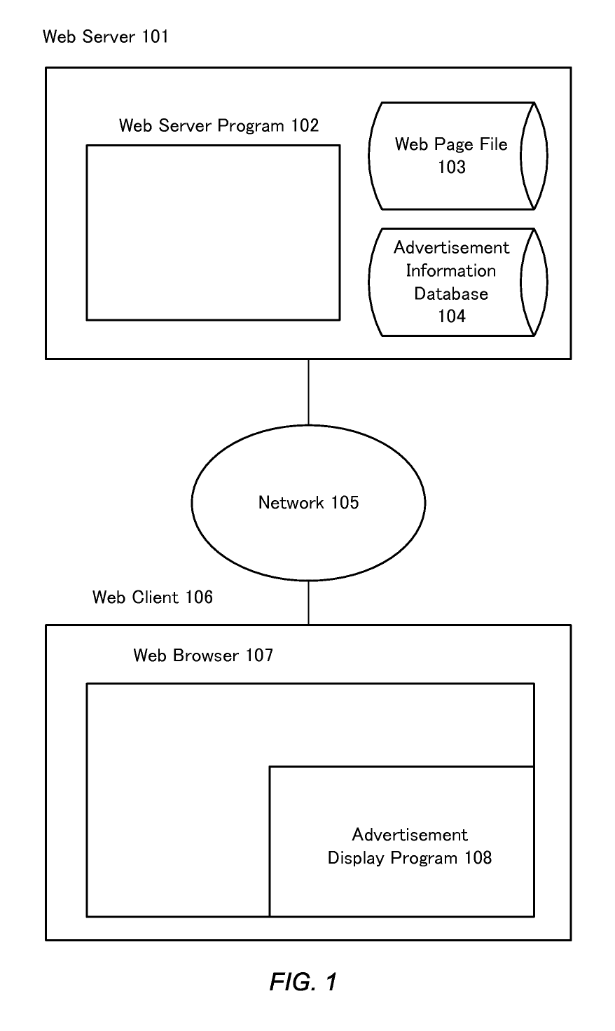

In FIG. 1, exemplary information system utilizing the present invention is shown. A web server 101 is a computer running a web server program 102. The web server program 102 is a set of computer programs that generate web pages containing advertisement links so that a web browser 107 can display those pages for users. A web page file 103 is a means to store the pages to be displayed on the web browser 107. An ad information database 104 is a means to store banner images, text links, URLs of landing pages, advertiser information, and so on. A network 105 is typically Internet. These elements are well-known technologies in today's Internet, so no further explanation is necessary for their inside mechanisms.

A web client 106 (typically, a personal computer, smart phone and tablet, but not limited thereto) is a device that runs the web browser 107 to display the web pages. The web browser is preferably a tab browser. These elements are well-known technologies in today's Internet, so no further explanation is necessary for their inside mechanisms.

An ad display program 108 is a program to display, replace and insert advertisements on the web pages, using the data stored in the ad information database 104. Typically, the ad display program 108 is written in JavaScript (trademark) and executed inside the web browser 107. However, it may be a program running on the web server or any other servers. The ad information database 104 can be anywhere in the network, not necessarily on the web server 101. Process logic of the ad display program 108 will be explained later.

In this specification, tab browsers include not only modern popular browsers such as Internet Explorer (trademark), Firefox (trademark) and Chrome (trademark), but also a browser (such as Safari (trademark)) that can contain multiple web pages simultaneously which users can switch rapidly, although the latter browsers does not have “tabs” (small protruding spaces for switching screen).

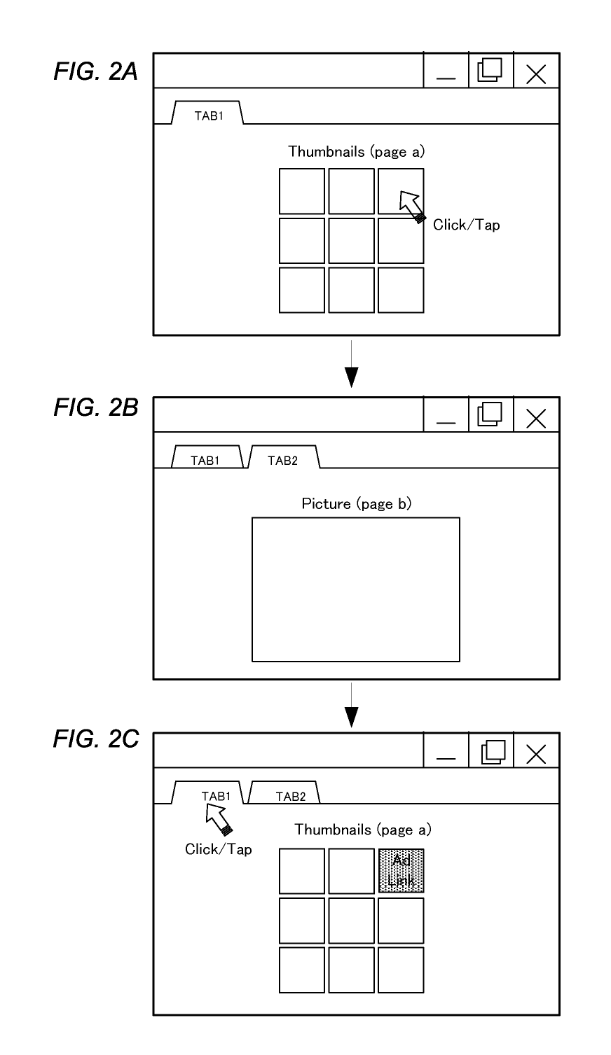

In FIG. 2A-FIG. 2C, an exemplary web browser screen utilizing the present invention are shown In FIG. 2A, one or more links (in this example, thumbnails of pictures) is displayed on a tab (TAB1) in a tab browser. When a user clicks one of these links, the web browser 107 displays the picture corresponding to the clicked link (thumbnail) on another tab (TAB2), as shown in FIG. 2B. This is a normal behavior that all the tab browsers would perform. Meanwhile, the ad display program 108 replaces the clicked thumbnail in TAB1 with a clickable banner ad, as shown in FIG. 2C.

Now, it is probable that the user visits TAB1 again in order to display another picture or see if he can delete TAB1. Then it is also probable that he finds the thumbnail he had clicked was replaced with the banner ad.

This banner ad necessarily gets attention of the user, resulting in higher click probability. In experiments performed by the inventor, it was shown that this method had noticeably higher CTR and CVR, compared to prior art methods.

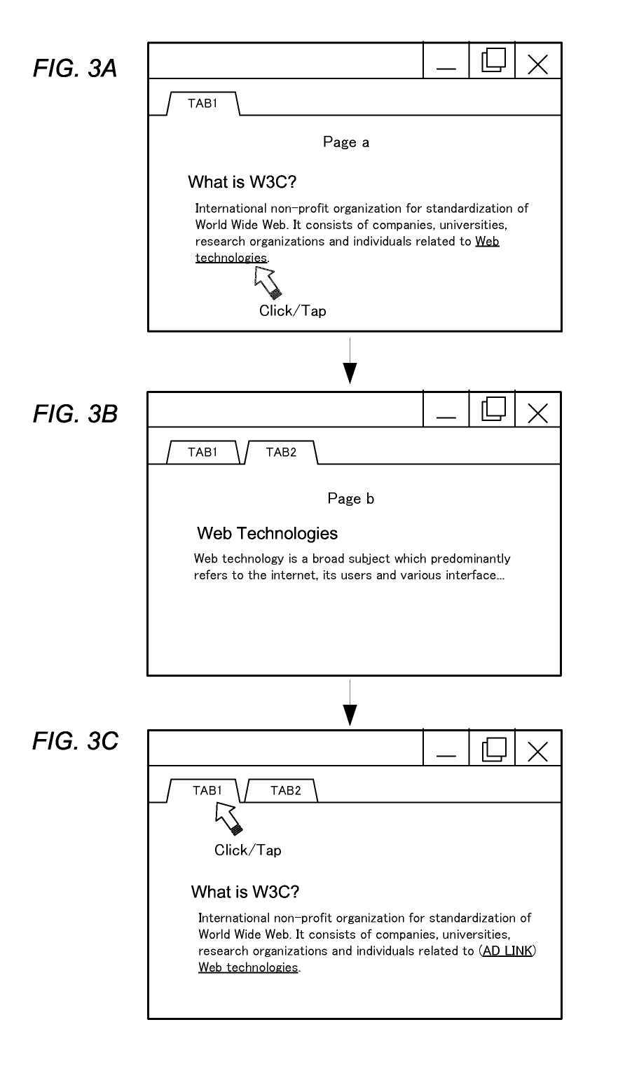

In FIG. 3A-FIG. 3C, another example of web browser screen utilizing the present invention is shown. In FIG. 3A, a text link (in this example, “Web technologies”) is displayed on a tab (TAB1). Similarly to the examples in FIG. 2A, when the user clicks the text link, the information corresponding to the clicked link is displayed on another tab (TAB2), as shown in FIG. 3B. Similarly to the examples in FIG. 2B, the ad display program 108 inserts the text link ad near the clicked link (in this example, “Web technologies”) on TAB1, as shown in FIG. 3C. Because it is probable the user begin reading again at the point where he clicked the link, the inserted ad necessarily gets attention of the user, resulting in higher CTR and CVR.

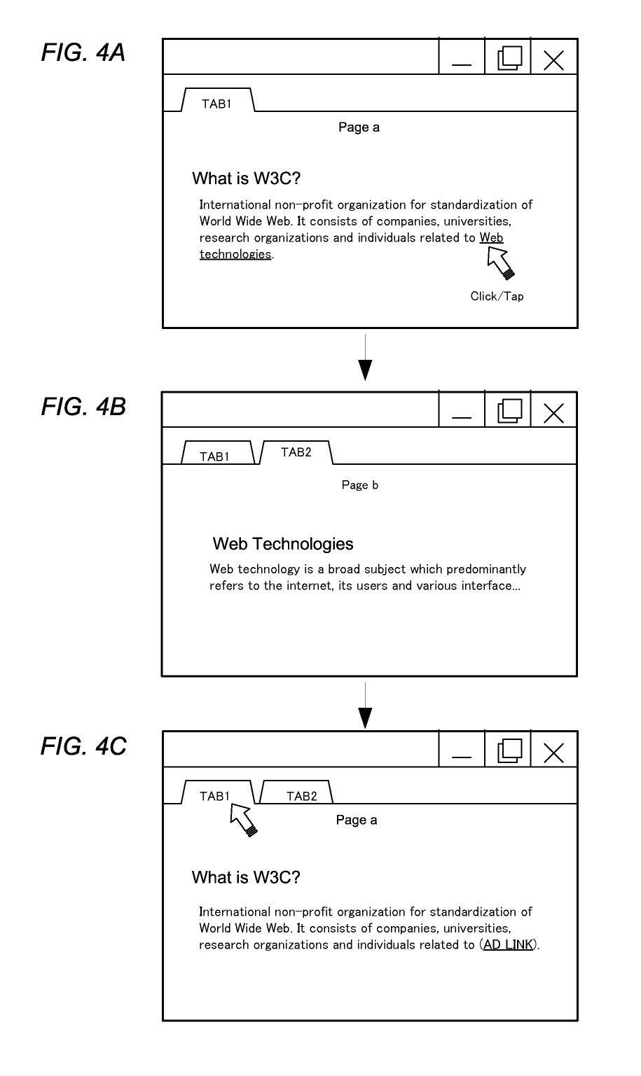

As shown in FIG. 4A-FIG. 4C, the ad display program 108 may replace (not insert) the clicked link with a text link ad. In this method, the display layout change can be kept minimal before and after displaying the ad links.

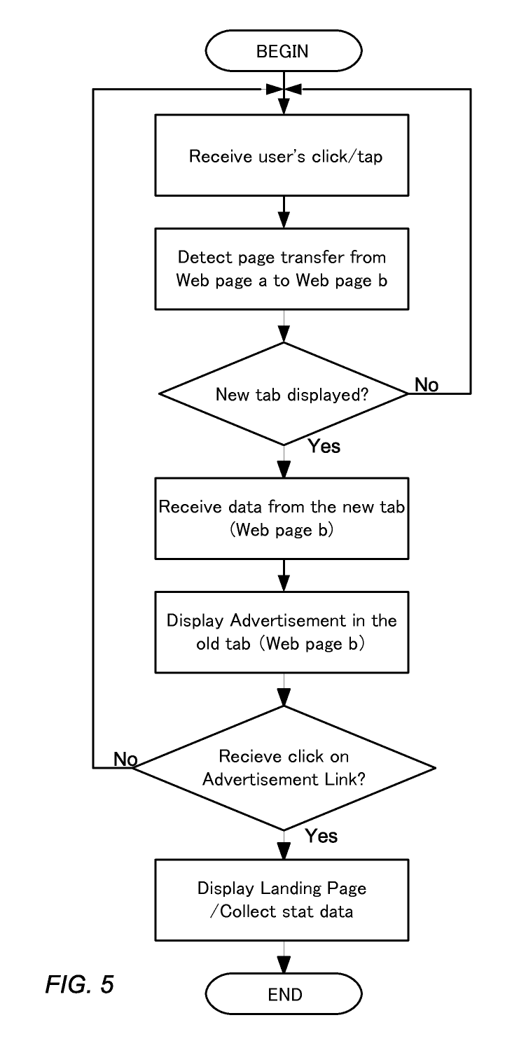

In FIG. 5, an exemplary flow chart of the ad display program 108 to execute a method of the present invention shown in FIG. 2A-FIG. 2C, FIG. 3A-FIG. 3C, and FIG. 4A-FIG. 4C on computers.

The explanation so far assumed a use of tab browser (here, a tab browser means a browser that contains multiple pages simultaneously that can be switched rapidly by the user). Though advertisement methods of the present invention are expected to be most effective in tab browser environments, they can also be applied to other non-tab browser environments.

That is, after an ad is displayed on a separate window as a result of the user's clicking a link (or a thumbnail), the ad display program 108 may replace the clicked link (or thumbnail) on the original window with a link ad (or a banner ad), or insert a text ad near the clicked link on the original window.

Compared to prior arts, the present invention has the following significant technical advantages. 1) Since ads are placed where the user naturally glances, higher ad efficiency is attained without flashy designs. This results in more sophisticated web designs and more spaces for a useful content, making it easy to obtain repeating visitors. 2) Similarly, ads do not have to be displayed in the initial page, resulting in more sophisticated web designs and more space for a useful content, making it easy to obtain repeating visitors. 3) Since ads are displayed after a user clicks a link for the information he wants and have left the tab, and they are displayed on the old tab that the user does not need any more, the user is less annoyed by the ads. 4) Ads can be displayed on the space where ad placements were not expected at the initial design time. 5) Even when the screen space available for ads is limited, and adding more ads is difficult to, advertisement profitability can be improved. 6) Its execution logic is simple and easy to implement on computer systems.

What is claimed is:

1. An advertisement display method executed on a web browser, comprising:
in response to a user's click operation on a first link in a first screen area, displaying an object corresponding to the first link in a second screen area; and
replacing the first link in the first screen area with an advertisement link.

2. A method according to claim 1, wherein:
the first screen area is a tab of the web browser; and
the second screen area is another tab of the web browser.

3. A method according to claim 1, wherein:
the first link is a thumbnail; and
the object corresponding to the first link is an image.

4. A method according to claim 2, wherein:
the first link is a thumbnail; and
the a first object is an image.

5. A method according to claim 1, wherein:
the advertisement link is a web banner ad.

6. A method according to claim 2, wherein:
the advertisement link is a web banner ad.

7. A method according to claim 3, wherein:
the advertisement link is a web banner ad.

8. A method according to claim 4, wherein:
the advertisement link is a web banner ad.

9. An advertisement display method executed on a web browser, comprising:
in response to a user's click operation on a first link in a first screen area, displaying information corresponding to the first link in a second screen area; and
inserting an advertisement link near the first link in the first screen area.

10. A method according to claim 9, wherein:
the first screen area is a tab of the web browser; and
the second screen area is another tab of the web browser.

11. A method according to claim 9, wherein:
the advertisement link is a text link ad.

12. A method according to claim 10, wherein:
the advertisement link is a text link ad.

13. A non-transitory computer readable medium storing a program causing a computer to execute an advertisement display process executed on a web browser, comprising:
in response to a user's click operation on a first link in a first screen area, displaying an object corresponding to the first link in a second screen area; and
replacing the first link in the first screen area with an advertisement link.

14. A non-transitory computer readable medium according to claim 13, wherein:
the first screen area is a tab of the web browser; and
the second screen area is another tab of the web browser.

15. A non-transitory computer readable medium according to claim 13, wherein:
the first link is a thumbnail; and
the object corresponding to the first link is an image.

16. A non-transitory computer readable medium according to claim 14, wherein:
the first link is a thumbnail; and
the a first object is an image.

17. A non-transitory computer readable medium according to claim 13, wherein:
the advertisement link is a web banner ad.

18. A non-transitory computer readable medium according to claim 14, wherein:
the advertisement link is a web banner ad.

19. A non-transitory computer readable medium according to claim 15, wherein:
the advertisement link is a web banner ad.

20. A non-transitory computer readable medium according to claim 16, wherein:
the advertisement link is a web banner ad.
